(19) United States
(12) Patent Application Publication
(10) Pub. No.: US 2026/0152993 A1
(43) Pub. Date: Jun. 4, 2026

(54) Under-Door Seal

(71) Applicant: Alchin Long Group IP Pty Limited, Wetherill Park (AU)

(72) Inventor: Trevor David Leisk, Sydney (AU)

(21) Appl. No.: 19/122,370

(22) PCT Filed: Oct. 20, 2023
(86) PCT No.: PCT/AU2023/051046

§ 371 Date: Apr. 18, 2025

(30) Foreign Application Priority Data
Oct. 21, 2022 (AU) 2022903117

(51) Int. Cl. E06B 7/18

(52) U.S. Cl. CPC E06B 7/18

(57) ABSTRACT

A seal assembly (100) for sealing a door gap (12), the seal assembly (100) including: a body (110) for attaching the seal assembly (100) to a door (10); a blade (150) mounted to the body (110) so as to be movable relative to the body (110) in a sealing direction (102) between a retracted position and a scaling position, wherein the blade (150) includes a first blade portion (160) and a second blade portion (170) that are configured so as to allow a blade width (154) to be adjusted.

### RELATED APPLICATIONS

The present application claims convention priority from Australian Provisional Patent Application No. 2022903117, the contents of which are incorporated herein in their entirety by reference thereto.

### FIELD

This invention relates to an under-door seal.

### BACKGROUND

A common pathway for forcing entry through locked and/or closed doors is to insert tools through the commonly available gap between the door and the floor. Tools may include fibre optic cameras, complex articulated mechanisms, or a simple angled handle-puller. Under-door seals are commonly used to prevent movement of air, and especially oxygen, through this gap, and are used, for example, in fire doors. Similar seals may also be used for acoustically sealing doors. However, such seals are often designed using compliant materials, which remain vulnerable to the forced insertion of above-mentioned tools through the gap.

Disclosed in Australian Innovation US2012101071, which is incorporated herein in its entirety by reference thereto, is an under-door seal using a descending metal plate to address these problems. However, improvements to the disclosed design remain possible.

### SUMMARY

It is an object of the present invention to at least substantially address one or more of the above disadvantages of existing under-door seals, or at least provide a useful alternative to the above mentioned

In a first aspect the present invention provides a seal assembly for sealing a door gap, the seal assembly including:
a body for attaching the seal assembly to a door;
a blade mounted to the body so as to be movable relative to the body in a sealing direction between a retracted position and a sealing position, the blade having a drive rack;
an actuator bar mounted to the body so as to be moveable relative to the body in an actuating direction between a retracted position and a sealing position, the actuator bar having an actuator rack;
a drive gear located between the drive rack and the actuator rack, so that movement of the actuator bar in the actuating direction results in movement of the blade in the sealing direction.

Preferably, the actuating direction is perpendicular to the sealing direction.

Preferably, the seal assembly further includes a roller mounted to the body to guide movement of the actuator bar along the actuating direction.

Preferably, the roller abuts the actuator bar opposite the engagement of the drive gear with the actuator rack.

Preferably, the actuator bar includes a recess located to receive the roller, a first end of the recess corresponding to the retracted position and a second end of the recess corresponding to the sealing position, such that movement of the actuator bar beyond the retracted and sealing positions is resisted by the roller engaging the end of the recess.

Preferably, the blade is at least partially formed from a non-compliant material to resist penetration through the door gap, preferably a metal.

Preferably, the seal assembly further includes a bias member between the body and the actuator bar to bias the actuator bar to one of the retracted position and the sealing position.

Preferably, the bias member is oriented parallel to the actuator direction.

In a second aspect, the present invention provides a seal assembly for sealing a door gap, the seal assembly including:
a body for attaching the seal assembly to a door;
a blade mounted to the body so as to be movable relative to the body in a sealing direction between a retracted position and a sealing position,
wherein the blade includes a first blade portion and a second blade portion that are configured so as to allow a blade width to be adjusted.

Preferably, the body includes a first body portion and a second portion that are each movably connected to the body so as to allow a body width to be adjusted.

Preferably, the blade includes a blade portion, and
wherein each blade portion has a slot and is connected to the blade portion by a bolt extending through the slot to allow the blade portion to move relative to the blade portion for adjustment of the blade width.

Preferably, each blade portion has three or more slots and is connected to the blade body by a bolt extending through each slot.

Preferably, the movement of the body portions is independent of the movement of the blade portions.

Preferably, the first blade portion includes a rack and the second blade portion includes a pinion gear that engages the rack of the first blade portion, such that a movement of the first blade portion for adjusting the blade width causes corresponding movement of the second blade portion for adjusting the blade width.

Preferably, the rack of the second blade portion is located symmetrically about a center line of the blade, such that the blade width remains symmetrical about the center line during movement of the blade portions for adjusting the blade width.

Preferably, the blade includes a releasable fastener that extends from the blade body to the first and second blade portions, wherein the fastener is securable to fix the first and second blade portions relative to the blade body.

Preferably, the first and second blade portions each include a lock slot, wherein the releasable fastener is received by the lock slots of the first and second blade portion such that the fastener is securable in a variety of relative positions between the blade portions and the blade body.

Preferably, the first blade portion has a recess for accommodating the second blade portion and the second blade portion has a recess for accommodating the first blade portion, and
wherein the blade portions are configured to be overlapping in an unexpanded position.

### BRIEF DESCRIPTION OF THE DRAWING

Preferred embodiments of the present invention will now be described by way of example, with reference to the accompanying drawings, wherein:

FIG. 1 is an isometric view of a seal assembly according to a preferred embodiment of the invention.

FIG. 2 is an isometric view of the seal assembly of FIG. 1 without a cover.

FIG. 3 is an exploded view of the seal assembly of FIG. 1.

FIG. 4 is a front view of the seal assembly of FIG. 1 without the cover.

FIG. 5 is a front view of the seal assembly of FIG. 1 without the cover and without blade portions.

FIG. 6 is a rear view of the seal assembly of FIG. 1 without the cover.

FIG. 7 is an isometric section view of the seal assembly of FIG. 1 without the cover.

### DETAILED DESCRIPTION

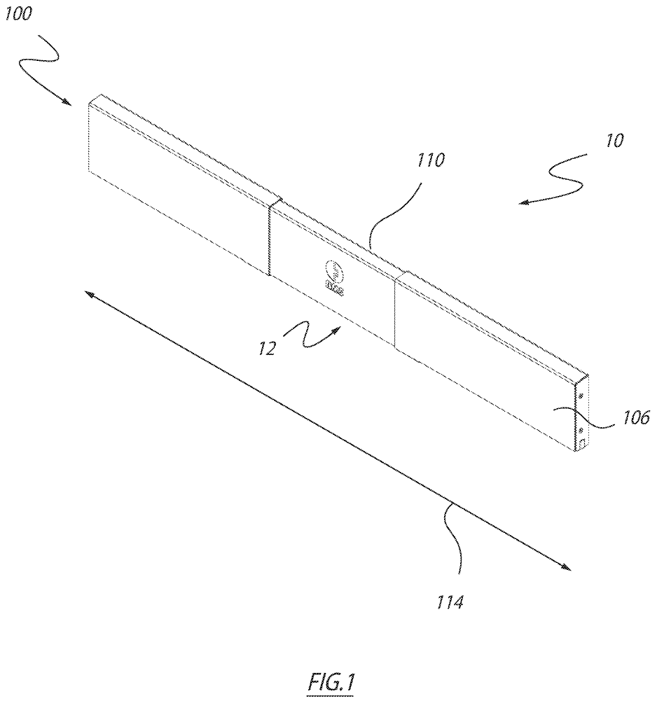

According to a preferred embodiment, shown in FIGS. 1 to 7, a seal assembly 100 for sealing a door gap 12 includes a body 110, having a body width 114, for attaching the seal assembly 100 to a door 10. FIG. 1 shows the seal assembly 100 with a cover 106 installed to obstruct access to the other components of the seal assembly 100.

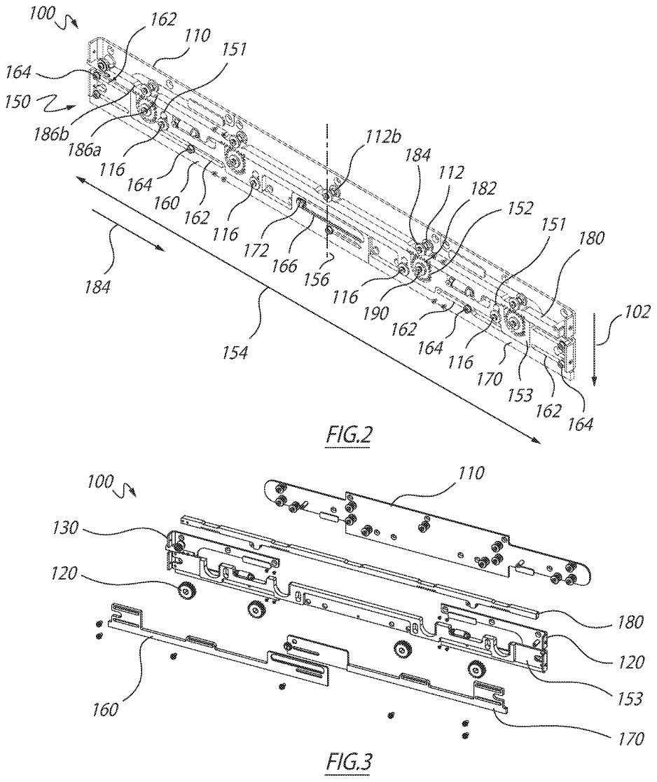

Moving to FIG. 2, which shows the seal assembly 100 with the cover 106 removed. The seal assembly 100 includes a blade 150, having a blade width 154, mounted to the body 110 so as to be movable relative to the body 110. To this extent, the body 110 includes one or more blade bolts 116 which are received by one or more first slots 151 located in a blade body 153 of the blade 150. The first slots 151 extend in a sealing direction 102, such that the blade 150 is moveable in the sealing direction 102 between a retracted position and a sealing position, determined by the extent of the first slots 151, as best seen in FIG. 5. FIG. 2 shows the blade 150 in the retracted position. The blade body 153 further includes a drive rack 152 extending in the sealing direction 102. Preferably, the blade 150 is at least partially formed from a non-compliant material, such as metal, to resist penetration through the door gap 12.

Remaining with FIG. 2, the seal assembly 100 further includes an actuator bar 180 mounted to the body 110 so as to be moveable relative to the body 110 in an actuating direction 104. The actuator bar 180 includes an actuator rack 182 extending in the actuating direction 104. The seal assembly 100 also includes a drive gear 190 located between the drive rack 152 and the actuator rack 182 so that the movement of the actuator bar 180 in the actuating direction 104 results in movement of the blade 150 in the sealing direction 102. Preferably, the actuating direction 104 is perpendicular to the sealing direction 102. Preferably, the seal assembly 100 includes a plurality of drive gears 190, each with a corresponding drive rack 152 and a corresponding actuator rack 182.

The seal assembly 100 further includes a roller 112 mounted to the body 110 to guide movement of the actuator bar 180 along the actuating direction 104. The roller 112 is located along the actuator bar 180 so that the roller 112 abuts the actuator bar 180 opposite the engagement of the drive gear 190 with the actuator rack 182. The actuator bar 180 also preferably includes a recess 184 having a first end 186a and a second end 186b. The recess 184 is located to receiver the roller 112, so that the first end 186a corresponds to the retracted position of the blade 150 and the second end 186b corresponds to the sealing position of the blade 150. Movement of the actuator bar 180 beyond the retracted and sealing positions of the blade 150 is limited by the resistance of the roller 112 engaging the respective end 186a,b of the recess 184. Preferably the seal assembly 100 includes a plurality of rollers 112, and the actuator bar 180 having a respective recess 184 for each roller 112. The seal assembly 100 may also include one or more rollers 112b that are not located opposite a drive gear 190.

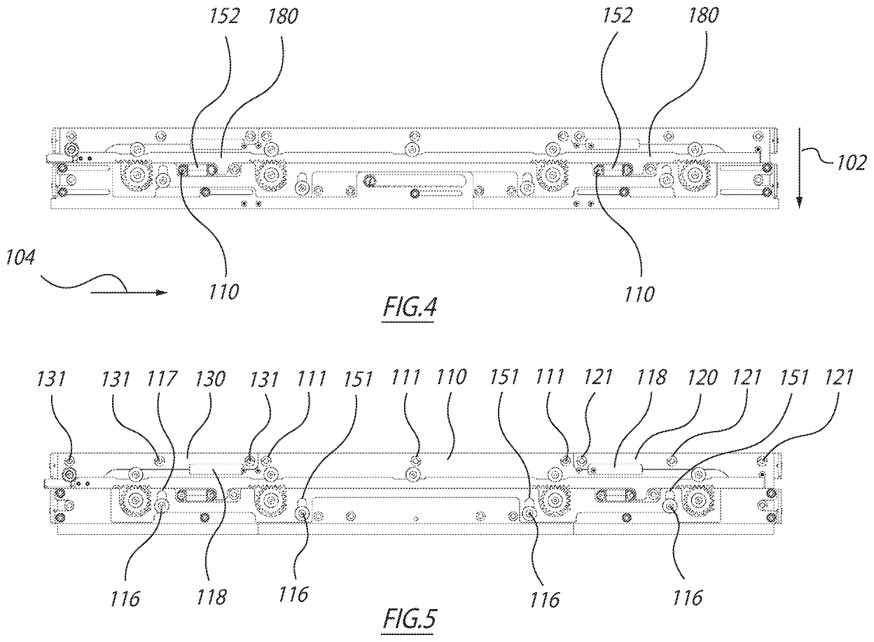

As best seen in FIG. 4, the seal assembly 100 further includes a bias member 192 between the body 110 and the actuator bar 180 to bias the actuator bar 180. While the preferred embodiment shows the bias member 192, a spring in this case, biasing the actuator bar 180 toward the retracted position, it will be appreciated that it is a straightforward change to reverse the behavior of the bias member 192 to bias the actuator bar 180 toward the sealing position. Preferably, the bias member 192 is oriented, and operates, parallel to the actuating direction 104. Preferably, the seal assembly 100 includes two or more bias members 192.

It will be appreciated that the above-discussed mechanism of actuating the blade 150 using the drive rack 152, drive gear 190, and actuator rack 182 is applicable to a broad range of under-door seal assemblies. The preferred embodiment includes a further development in seal assemblies to provide an adjustable seal assembly 100. These two developments may be used independently, or together, as may be desired by the person skilled in the art.

Returning to FIG. 2, the blade 150 of the seal assembly 100 may include a first blade portion 160 and a second blade portion 170 that are movable connected so as to allow the blade width 154 to be adjusted. Specifically, each blade portion 160, 170 has a second slot 162, preferably extending in the actuating direction, and is connected to the blade body 153 by a bolt 164 extending through the second slot 162. Each blade portion 160, 170 may thus move along the extension of the second slot 162 relative to the blade body 153 for adjustment of the blade width 154. Preferably, each blade portion 160, 170 has three or more second slots 162 and is connected to the blade body 153 by bolts 164 extending through the respective second slots 162.

As shown in FIG. 4, preferably the first blade portion 160 includes a rack 166 and the second blade portion 170 includes a pinion gear 172 that engages the rack 166 of the first blade portion 160, such that movement of the first blade portion 160 along the second slots 162 to adjust the blade width 154 causes corresponding movement of the second blade portion 170 for adjusting the blade width 154, and vice versa. Preferably, the rack 166 is located symmetrically about a center line 156 of the blade 150, such that the blade width 154 remains symmetrical about the center line 156 during movement of the blade portions 160, 170.

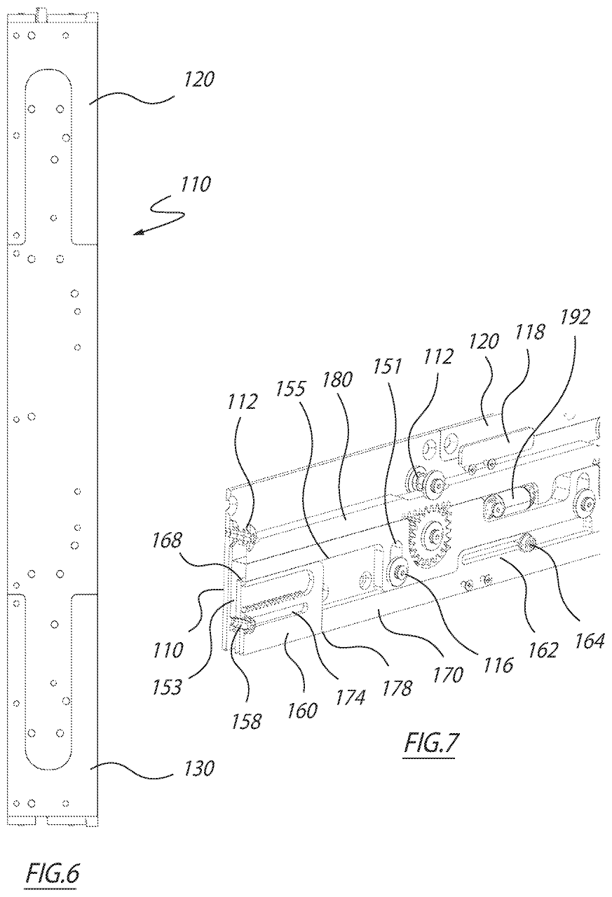

As shown in FIG. 7, the blade portions 160, 170 are configured to be overlapping in an unexpended position. To this end, the first blade portion 160 has a recess 168 for accommodating the second blade portion 170, and the second blade portion 170 has a recess 178 for accommodating the first blade portion 160. The blade 150 includes a releasable fastener 158 that extends from the blade body 153 to the blade portions 160, 170. The fastener 158 is securable to fix the first and second blade portions 160, 170 relative to the blade body 153, so that when movement of the blade body 153 is caused by the actuator bar 180, the blade portions 160, 170 move together with the blade body 153. The first and second blade portions 160, 170 each include a lock slot 174, the fastener 158 being received by the lock slots 174, such that the fastener 158 is securable in a variety of relative positions between the blade portions 160, 170 and the blade body 153.

The blade body 153 preferably includes a pocket 155 dimensioned to receive at least a part of each of the blade portions 160, 170. Preferably, the pocket 155 is located along the center line 156 and the rack 166 and pinion gear 172 are located in the pocket 155. Preferably, the blade body 153 extends substantially the entirety of the minimum body width 114 of the seal assembly 100.

Moving to FIG. 6, the body 110 also includes a first body portion 120 and a second body portion 130 that are each movably connected to the body 110 so as to allow the body width 114 to be adjusted. Preferably, the body portions 120, 130 are movable in the actuating direction 104. Preferably, the movement of the body portions 120, 130 is independent of the movement of the blade portions 160, 170. As shown in FIG. 5, the body 110 includes guide plates 118 that create a gap between the door 10 and the guide plate 118, so that the body portions 120, 130 can be adjusted after a central portion of the body 110 has been mounted to the door 10 using apertures 111. The body portions 120, 130 can then be adjusted as desired and mounted using their respective apertures 121, 131.

Use of the seal assembly 100 will now be discussed.

The seal assembly 100 is moved adjacent to the door 10 whose door gap 12 is to be protected using the seal assembly 100. The body 110 is attached to the door by fasteners (not shown) received through the apertures 111. The body portions 120, 130 may then be extended from the body 110 to adjust the body width 114 to suit the door 10. The body portions 120, 130 are then attached to the door 10 by fasteners (not shown) received through apertures 121, 131, respectively. The blade width 154 is similarly adjusted to suit the door 10 by moving the blade portions 160, 170 relative to the blade body 153. The engagement of the rack 166 with the pinion gear 172 ensures that the movement of the blade portions 160, 170 is symmetrical about the center line 156. Once the desired blade width 154 has been reached, the blade portions 160, 170 are fixed relative to the blade body 153 using the releasable fastener 158 engaging the lock slot 174.

To actuate the seal assembly 100, the actuator bar 180 is moved in the actuating direction 104 from the retracted position shown in FIG. 2 to the sealing position. This movement may, for example, be caused by an electromagnetic actuator (not shown) controlled by an electronic controller. In another embodiment, the movement is caused by the turning of a lock (not shown) or rotation of a handle (not shown). The movement of the actuator bar 180 along the actuating direction 104 is translated by the pinion gear 172 into a movement of the blade 150 along the scaling direction 102. The recess 184 of the actuator bar 180 resists movement of the actuator bar 180 beyond the scaling position.

Advantages of the seal assembly 100 will now be discussed.

Because of the use of the actuator bar 180 with a drive gear 190 to move the blade 150 between the retracted position and the sealing position, the mechanism is robust and resistant to ingress of contaminants compared to a friction-based system. The use of an actuating direction 104 that is perpendicular to the sealing direction 102 reduces the size of the seal assembly 100. The use of the rollers 112 to guide the movement of the actuator bar 180 assists to resists the deflection of the actuator bar 180 due to the force between the actuator bar 180 and the drive gear 180 when moving the blade 150 between positions. The rollers 112 also assist in controlling the extent of the motion of the blade 150 by engaging the recesses 184. The use of a non-compliant material, such as a metal, for the blade 150 reduces the vulnerability of the seal assembly 100 to forced entry.

The use of the bias member 192 assists in ensuring that the seal assembly 100 is engaged in the desired situations. The use of the blade 150 with moveable blade portions 160, 170 allows the blade width 154 to be adjusted to different doors 10, so that the door gap 12 is sealed better. The use of the body 110 with body portions 120, 130 allows the load of the seal assembly 100 to be more evenly distributed across the door 10, and to ensure that the blade 150 remains aligned with the door gap 12. The use of second slots 162 and bolts 164 assist orthogonal movement of the blade portions 160, 170 relative to the blade body 153 so that the blade 150 remains aligned with the door gap 12. By keeping the movement of the blade portions 160, 170 and body portions 120, 130 independent from each other, installation steps are easier to complete independently and accurately. The use of the rack 166 and pinion gear 172 to ensure symmetrical movement of the blade portions 160, 170 assist with distributing the load on the blade 150 across the seal assembly 100. The use of the recesses 168, 178 reduces the size of the seal assembly 100. The use of the fastener 158 allows the blade width 154 to be fixed in a variety of relative positions, to accommodate a variety of door 10 geometries.

### Integers:

| | |
|---|---|
| 10 | door |
| 12 | door gap |
| 100 | seal assembly |
| 102 | sealing direction |
| 104 | actuating direction |
| 106 | cover |
| 110 | body |
| 111 | apertures |
| 112 | roller |
| 114 | body width |
| 116 | blade bolts |
| 118 | guide plates |
| 120 | first body portion |
| 121 | aperture |
| 130 | second body portion |
| 131 | aperture |
| 150 | blade |
| 151 | first slot |
| 152 | drive rack |
| 153 | blade body |
| 154 | blade width |
| 155 | pocket |
| 156 | center line |
| 158 | releasable fastener |
| 160 | first blade portion |
| 162 | second slot |
| 164 | bolt |
| 166 | rack |
| 168 | recess |
| 170 | second blade portion |
| 172 | pinion gear |
| 174 | lock slot |
| 178 | recess |
| 180 | actuator bar |
| 182 | actuator rack |
| 184 | recess |
| 186a, b | end of recess |
| 190 | drive gear |
| 192 | bias member |

1. A seal assembly for sealing a door gap, the seal assembly including:
a body for attaching the seal assembly to a door; and
a blade mounted to the body so as to be movable relative to the body in a sealing direction between a retracted position and a sealing position, wherein the blade includes a first blade portion and a second blade portion that are configured so as to allow a blade width to be adjusted.

2. The seal assembly of claim 1, wherein the body includes a first body portion and a second portion that are each movably connected to the body so as to allow a body width to be adjusted.

3. The seal assembly of claim 2, wherein the blade includes a blade portion, and wherein each blade portion has a slot and is connected to the blade portion by a bolt extending through the slot to allow the blade portion to move relative to the blade portion for adjustment of the blade width.

4. The seal assembly of claim 3, wherein each blade portion has three or more slots and is connected to the blade body by a bolt extending through each slot.

5. The seal assembly of claim 2, wherein the movement of the body portions is independent of the movement of the blade portions.

6. The seal assembly of claim 1, wherein the first blade portion includes a rack and the second blade portion includes a pinion gear that engages the rack of the first blade portion, such that a movement of the first blade portion for adjusting the blade width causes corresponding movement of the second blade portion for adjusting the blade width.

7. The seal assembly of claim 6, wherein the rack of the second blade portion is located symmetrically about a center line of the blade, such that the blade width remains symmetrical about the center line during movement of the blade portions for adjusting the blade width.

8. The seal assembly of claim 7, wherein the blade includes a releasable fastener that extends from the blade body to the first and second blade portions, wherein the fastener is securable to fix the first and second blade portions relative to the blade body.

9. The seal assembly of claim 8, wherein the first and second blade portions each include a lock slot, wherein the releasable fastener is received by the lock slots of the first and second blade portion such that the fastener is securable in a variety of relative positions between the blade portions and the blade body.

10. The seal assembly of claim 1, wherein the first blade portion has a recess for accommodating the second blade portion and the second blade portion has a recess for accommodating the first blade portion, and wherein the blade portions are configured to be overlapping in an unexpanded position.

11. A seal assembly for sealing a door gap, the seal assembly including:
a body for attaching the seal assembly to a door;
a blade mounted to the body so as to be movable relative to the body in a sealing direction between a retracted position and a sealing position, the blade having a drive rack;
an actuator bar mounted to the body so as to be moveable relative to the body in an actuating direction between a retracted position and a sealing position, the actuator bar having an actuator rack; and
a drive gear located between the drive rack and the actuator rack, so that movement of the actuator bar in the actuating direction results in movement of the blade in the sealing direction.

12. The seal assembly of claim 11, wherein the actuating direction is perpendicular to the sealing direction.

13. The seal assembly of claim 11, wherein the seal assembly further includes a roller mounted to the body to guide movement of the actuator bar along the actuating direction.

14. The seal assembly of claim 13, wherein the roller abuts the actuator bar opposite the engagement of the drive gear with the actuator rack.

15. The seal assembly of claim 13, wherein the actuator bar includes a recess located to receive the roller, a first end of the recess corresponding to the retracted position and a second end of the recess corresponding to the sealing position, such that movement of the actuator bar beyond the retracted and sealing positions is resisted by the roller engaging the end of the recess.

16. The seal assembly of claim 11, wherein the blade is at least partially formed from a non-compliant material to resist penetration through the door gap, preferably a metal.

17. The seal assembly of claim 11, wherein the seal assembly further includes a bias member between the body and the actuator bar to bias the actuator bar to one of the retracted position and the sealing position.

18. The seal assembly of claim 17, wherein the bias member is oriented parallel to the actuator direction.
